(19) United States
(12) Patent Application Publication
(10) Pub. No.: US 2023/0361268 A1
(43) Pub. Date: Nov. 9, 2023

(54) NON-AQUEOUS ELECTROLYTE SECONDARY BATTERY

(71) Applicant: Panasonic Energy Co., Ltd., Moriguchi-shi, Osaka (JP)

(72) Inventors: Mai Yokoi, Tokushima (JP); Tomoki Ikeda, Tokushima (JP); Nobuhiro Sakitani, Osaka (JP)

(73) Assignee: Panasonic Energy Co., Ltd., Moriguchi-shi, Osaka (JP)

(21) Appl. No.: 18/038,135

(22) PCT Filed: Nov. 17, 2021
(86) PCT No.: PCT/JP2021/042170

§ 371 Date: May 22, 2023

(30) Foreign Application Priority Data
Nov. 24, 2020 (JP) 2020-194531

(51) Int. Cl. H01M 4/131; H01M 10/0587

(52) U.S. Cl. CPC H01M 4/131; H01M 10/0587; H01M 2004/028

(57) ABSTRACT

A non-aqueous electrolyte secondary battery including a wound electrode body in which a positive electrode and a negative electrode are wound with a separator therebetween; the positive electrode having a positive electrode current collector, a first positive electrode mixture layer formed on a first surface of the positive electrode current collector which faces the outside of the electrode body, and a second positive electrode mixture layer formed on a second surface of the positive electrode current collector which faces the inside of the electrode body; the first positive electrode mixture layer and the second positive electrode mixture layer each containing a positive electrode active material; and the dibutyl phthalate oil absorption amount of the positive electrode active material contained in the first positive electrode mixture layer being less than the dibutyl phthalate oil absorption amount of the positive electrode active material contained in the second positive electrode mixture layer.

### TECHNICAL FIELD

The present disclosure relates to a non-aqueous electrolyte secondary battery.

### BACKGROUND

In recent years, as a secondary battery having a high output and a high energy density, a non-aqueous electrolyte secondary battery which includes a positive electrode, a negative electrode, and a non-aqueous electrolyte and performs charge and discharge by moving lithium ions and the like between the positive electrode and the negative electrode is widely used.

For example, in order to provide a non-aqueous electrolytic secondary battery having both excellent output characteristics and good charge-discharge cycle characteristics, Patent Literature 1 proposes use of a positive electrode including: a positive electrode current collector; and a positive electrode active material layer, wherein the positive electrode active material layer includes two layers divided in the thickness direction, the two layers being composed of an upper layer relatively close to the surface of the positive electrode active material layer and a lower layer relatively close to the positive electrode current collector, the dibutyl phthalate oil absorption per unit mass of the lower layer is larger than the dibutyl phthalate oil absorption per unit mass of the upper layer, and the thickness of the lower layer is less than or equal to 40% when the thickness of the entire positive electrode active material layer is 100%.

In addition, for example, Patent Literature 2 proposes a positive electrode active material including a powder of a lithium-containing composite oxide and having a dibutyl phthalate oil absorption of 20 mL/100 g to 40 mL/100 g.

### CITATION LIST

### Patent Literature

Patent Literature 1: JP 2016-100241 A
Patent Literature 2: JP 2005-515465 A

### SUMMARY

### Technical Problem

An object of the present disclosure is to provide a non-aqueous electrolyte secondary battery capable of suppressing deterioration of charge-discharge cycle characteristics.

### Solution to Problem

A non-aqueous electrolyte secondary battery according to one aspect of the present disclosure includes: an electrode assembly including a positive electrode, a negative electrode, and a separator, the positive electrode and the negative electrode being wound with the separator interposed between the positive electrode and the negative electrode, the electrode assembly being a wound electrode assembly, wherein the positive electrode has: a positive electrode current collector; a first positive electrode mixture layer that is formed on a first face of the positive electrode current collector and faces an outside of the electrode assembly; and a second positive electrode mixture layer that is formed on a second face of the positive electrode current collector and faces an inside of the electrode assembly, the first positive electrode mixture layer and the second positive electrode mixture layer contain a positive electrode active material, and a dibutyl phthalate oil absorption of the positive electrode active material contained in the first positive electrode mixture layer is smaller than a dibutyl phthalate oil absorption of the positive electrode active material contained in the second positive electrode mixture layer.

### Advantageous Effects of Invention

According to one aspect of the present disclosure, deterioration of charge-discharge cycle characteristics can be suppressed.

### BRIEF DESCRIPTION OF DRAWINGS

FIG. 1 is a cross-sectional view of a non-aqueous electrolyte secondary battery as an example of an embodiment.

FIG. 2 is a cross-sectional view of a positive electrode which is an example of the embodiment.

### DESCRIPTION OF EMBODIMENTS

An example of the embodiment will be described with reference to the drawings. The non-aqueous electrolyte secondary battery of the present disclosure is not limited to the embodiment described below. The drawings referred to in the description of the embodiment are schematically illustrated.

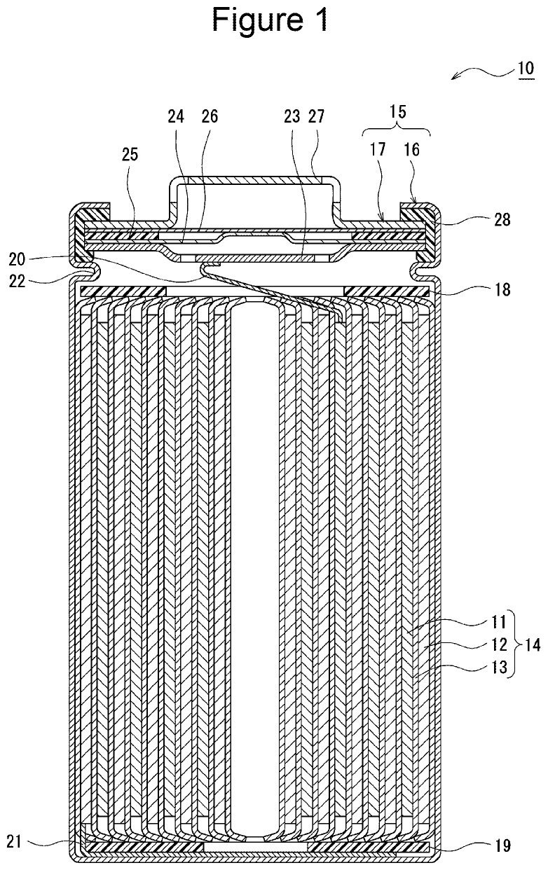

FIG. 1 is a cross-sectional view of a non-aqueous electrolyte secondary battery as an example of the embodiment. A non-aqueous electrolyte secondary battery 10 illustrated in FIG. 1 includes a wound electrode assembly 14 formed by winding a positive electrode 11 and a negative electrode 12 with a separator 13 interposed therebetween, a non-aqueous electrolyte, insulating plates 18 and 19 respectively disposed above and below the electrode assembly 14, and a battery case 15 that houses the above-described members. The battery case 15 includes a bottomed cylindrical case body 16, and a sealing assembly 17 that closes an opening of the case body 16. Examples of the battery case 15 include a bottomed cylindrical exterior can having a cylindrical shape, a rectangular shape, or the like, and a pouch exterior package formed by laminating a resin sheet and a metal sheet.

The case body 16 is, for example, a bottomed cylindrical metal exterior can. A gasket 28 is provided between the case body 16 and the sealing assembly 17 to ensure sealability of the inside of the battery. The case body 16 has, for example, a projecting portion 22 supporting the sealing assembly 17, and a part of a side face of the case body 16 projects inward to form the projecting portion 22. The projecting portion 22 is preferably formed in an annular shape along the circumferential direction of the case body 16, and supports the sealing assembly 17 on the upper face thereof.

The sealing assembly 17 has a structure in which a filter 23, a lower vent member 24, an insulating member 25, an upper vent member 26, and a cap 27 are stacked in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected to each other at the central portions of respective members, and the insulating member 25 is interposed between the peripheral parts of respective members. When the internal pressure of the non-aqueous electrolyte secondary battery 10 increases due to heat generated by an internal short circuit or the like, the lower vent member 24 deforms so as to push up the upper vent member 26 toward the cap 27 and breaks, and the current path between the lower vent member 24 and the upper vent member 26 is cut off, for example. When the internal pressure further increases, the upper vent member 26 breaks, and the gas is discharged from an opening of the cap 27.

In the non-aqueous electrolyte secondary battery 10 illustrated in FIG. 1, a positive electrode lead 20 attached to the positive electrode 11 extends to the sealing assembly 17 side through the through hole of the insulating plate 18, and a negative electrode lead 21 attached to the negative electrode 12 extends to the bottom side of the case body 16 through the outside of the insulating plate 19. The positive electrode lead 20 is connected to a lower face of the filter 23 which is a bottom plate of the sealing assembly 17 by welding or the like, and the cap 27 which is a top plate of the sealing assembly 17 electrically connected to the filter 23 serves as a positive electrode terminal. The negative electrode lead 21 is connected to the inner face of the bottom of the case body 16 by welding or the like, and the case body 16 serves as a negative electrode terminal.

Hereinafter, each component of the non-aqueous electrolyte secondary battery 10 will be described in detail.

[Positive Electrode]

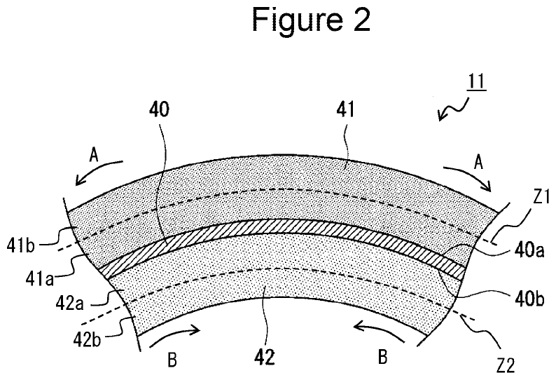

FIG. 2 is a cross-sectional view of a positive electrode which is an example of the embodiment. The positive electrode 11 includes a positive electrode current collector 40, a first positive electrode mixture layer 41 that is formed on a first face 40a of the positive electrode current collector 40 and faces the outside of the electrode assembly 14, and a second positive electrode mixture layer 42 that is formed on a second face 40b of the positive electrode current collector 40 and faces the inside of the electrode assembly 14. A foil of a metal which is stable in the potential range of the positive electrode 11, such as aluminum, a film in which the metal is disposed on a surface layer thereof, or the like can be used for the positive electrode current collector 40. The first positive electrode mixture layer 41 and the second positive electrode mixture layer 42 contain a positive electrode active material, and preferably further contain a binder, a conductive agent, and the like.

In the positive electrode 11, for example, a first positive electrode mixture slurry containing a positive electrode active material, a binder, a conductive agent, and the like is applied onto the first face 40a of the positive electrode current collector 40 and dried to form the first positive electrode mixture layer 41, and a second positive electrode mixture slurry containing a positive electrode active material, a binder, a conductive agent, and the like is applied onto the second face 40b of the positive electrode current collector 40 and dried to form the second positive electrode mixture layer 42. Then, the first positive electrode mixture layer 41 and the second positive electrode mixture layer 42 are rolled with a rolling roller or the like to obtain the positive electrode 11.

As illustrated in FIG. 2, the positive electrode 11 constituting the wound electrode assembly 14 is curved over the entire length in the longitudinal direction. The positive electrode 11 is produced in a flat plate state, and is curved by being wound together with the negative electrode 12 and the separator 13 at the time of producing the electrode assembly 14. The positive electrode 11 generally has a radius of curvature of about 1 mm to 100 mm, and the radius of curvature is different between the winding start side and the winding end side of the electrode assembly 14.

Since the positive electrode 11 is produced in a flat plate state, the convex face side is extended and the concave face side is compressed in a curved state. That is, as illustrated in FIG. 2, the first positive electrode mixture layer 41 that is formed on the first face 40a of the positive electrode current collector 40 and faces the outside of the electrode assembly 14 is mainly extended in the direction of the arrow A, and the second positive electrode mixture layer 42 that is formed on the second face 40b of the positive electrode current collector 40 and faces the inside of the electrode assembly 14 is mainly compressed in the direction of the arrow B. Then, in the first positive electrode mixture layer 41, voids are generated by the extension, and the permeation amount of the non-aqueous electrolyte tends to increase. Meanwhile, in the second positive electrode mixture layer 42, voids are reduced by the compression, and the permeation amount of the non-aqueous electrolyte tends to decrease. When there is a difference in the permeation amount of the non-aqueous electrolyte between the first positive electrode mixture layer 41 and the second positive electrode mixture layer 42, the reaction in the first positive electrode mixture layer 41 and the reaction in the second positive electrode mixture layer 42 become non-uniform, causing deterioration of the charge-discharge cycle characteristics.

Therefore, in the present embodiment, the dibutyl phthalate oil absorption of the positive electrode active material contained in the first positive electrode mixture layer 41 that is formed on the first face 40a of the positive electrode current collector 40 and faces the outside of the electrode assembly 14 is made smaller than the dibutyl phthalate oil absorption of the positive electrode active material contained in the second positive electrode mixture layer 42 that is formed on the second face 40b of the positive electrode current collector 40 and faces the inside of the electrode assembly 14. With such a configuration, the first positive electrode mixture layer 41 in which the permeation amount of the non-aqueous electrolyte tends to be large is made of a positive electrode active material having a small oil absorption, so that the permeation amount of the non-aqueous electrolyte is suppressed. In addition, the second positive electrode mixture layer 42 in which the permeation amount of the non-aqueous electrolyte tends to be small is made of a positive electrode active material having a large oil absorption, so that the permeation amount of the non-aqueous electrolyte is improved. As a result, it is presumed that the difference in the permeation amount between the non-aqueous electrolyte of the first positive electrode mixture layer 41 and the non-aqueous electrolyte of the second positive electrode mixture layer 42 is reduced, and the reaction in the first positive electrode mixture layer 41 and the reaction in the second positive electrode mixture layer 42 become uniform, so that deterioration of charge-discharge cycle characteristics is suppressed.

In the present embodiment, the dibutyl phthalate oil absorption of the positive electrode active material contained in the first positive electrode mixture layer 41 is preferably greater than or equal to 11 mL/100 g and less than or equal to 19 mL/100 g, more preferably greater than or equal to 12 mL/100 g and less than or equal to 18 mL/100 g, and still more preferably greater than or equal to 13 mL/100 g and less than or equal to 17 mL/100 g from the viewpoint of suppressing deterioration of charge-discharge cycle characteristics and the like. In addition, in the present embodiment, the dibutyl phthalate oil absorption of the positive electrode active material contained in the second positive electrode mixture layer 42 is preferably greater than or equal to 15 mL/100 g and less than or equal to 23 mL/100 g, more preferably greater than or equal to 16 mL/100 g and less than or equal to 22 mL/100 g, and still more preferably greater than or equal to 17 mL/100 g and less than or equal to 21 mL/100 g from the viewpoint of suppressing deterioration of charge-discharge cycle characteristics, and the like.

The value of the dibutyl phthalate oil absorption of the positive electrode active material contained in each of the first positive electrode mixture layer 41 and the second positive electrode mixture layer 42 in the present embodiment is an average value. That is, each of the first positive electrode mixture layer 41 and the second positive electrode mixture layer 42 may contain a plurality of positive electrode active materials having different dibutyl phthalate oil absorptions. For example, when the first positive electrode mixture layer 41 contains three types of positive electrode active materials (P1, P2, P3) having different dibutyl phthalate oil absorptions, the dibutyl phthalate oil absorption of the positive electrode active material contained in the first positive electrode mixture layer 41 is the dibutyl phthalate oil absorption of a mixture including the positive electrode active materials P1, P2, and P3. The same applies to the second positive electrode mixture layer 42.

When the oil absorption of the mixture including a plurality of positive electrode active materials in the first positive electrode mixture layer 41 is greater than or equal to 11 mL/100 g and less than or equal to 19 mL/100 g, the dibutyl phthalate oil absorptions of all the positive electrode active materials are desirably greater than or equal to 11 mL/100 g and less than or equal to 19 mL/100 g. However, when the dibutyl phthalate oil absorption of the mixture including a plurality of positive electrode active materials contained in the first positive electrode mixture layer 41 satisfies greater than or equal to 11 mL/100 g and less than or equal to 19 mL/100 g, the dibutyl phthalate oil absorption of each of the positive electrode active materials does not necessarily satisfy the above range. For example, when the first positive electrode mixture layer 41 contains two types of positive electrode active materials (P1, P2) having different dibutyl phthalate oil absorptions, if the dibutyl phthalate oil absorption of a mixture including the positive electrode active materials P1 and P2 is greater than or equal to 11 mL/100 g and less than or equal to 19 mL/100 g, the dibutyl phthalate oil absorption of the positive electrode active material P1 may be, for example, less than 11 mL/100 g, and the dibutyl phthalate oil absorption of the positive electrode active material P2 may be, for example, more than 19 mL/100 g. In this case, it is necessary to adjust the contents of the positive electrode active materials P1 and P2 so that the dibutyl phthalate oil absorption of the mixture including the positive electrode active materials P1 and P2 is greater than or equal to 11 mL/100 g and less than or equal to 19 mL/100 g.

Similarly, when the oil absorption of the mixture including a plurality of positive electrode active materials in the second positive electrode mixture layer 42 is greater than or equal to 15 mL/100 g and less than or equal to 23 mL/100 g, the dibutyl phthalate oil absorptions of all the positive electrode active materials are desirably greater than or equal to 15 mL/100 g and less than or equal to 23 mL/100 g. However, when the dibutyl phthalate oil absorption of the mixture including a plurality of positive electrode active materials contained in the second positive electrode mixture layer 42 satisfies greater than or equal to 15 mL/100 g and less than or equal to 23 mL/100 g, the dibutyl phthalate oil absorption of each of the positive electrode active materials does not necessarily satisfy the above range. For example, when the second positive electrode mixture layer 42 contains two types of positive electrode active materials (P1, P2) having different dibutyl phthalate oil absorptions, if the dibutyl phthalate oil absorption of a mixture including the positive electrode active materials P1 and P2 is greater than or equal to 15 mL/100 g and less than or equal to 23 mL/100 g, the dibutyl phthalate oil absorption of the positive electrode active material P1 may be, for example, less than 15 mL/100 g, and the dibutyl phthalate oil absorption of the positive electrode active material P2 may be, for example, more than 23 mL/100. In this case, it is necessary to adjust the contents of the positive electrode active materials P1 and P2 so that the dibutyl phthalate oil absorption of the mixture including the positive electrode active materials P1 and P2 is greater than or equal to 15 mL/100 g and less than or equal to 23 mL/100 g.

The dibutyl phthalate oil absorption of the positive electrode active material is a value measured in accordance with the dibutyl phthalate (DBP) absorption A method (mechanical method) defined in JIS K-6217-4 “Carbon black for rubber-fundamental characteristics-part 4: determination of DBP absorption”. Specifically, DBP is added to a sample (positive electrode active material) stirred by two blades at a constant speed using an absorption tester (manufactured by Asahi Souken Co., Ltd., model “S-500”), a change in viscosity characteristic at this time is detected by a torque detector, an output thereof is converted into torque by a microcomputer, and DBP corresponding to a torque at 100% of a generated maximum torque is converted per 100 g of the sample (positive electrode active material) to obtain a dibutyl phthalate oil absorption.

In the present embodiment, when the first positive electrode mixture layer 41 is divided into two equal parts in the thickness direction, the dibutyl phthalate oil absorption of the positive electrode active material contained in an upper half region 41b is preferably smaller than the dibutyl phthalate oil absorption of the positive electrode active material contained in a lower half region 41a. This makes it possible to more effectively suppress the permeation amount of the non-aqueous electrolyte into the first positive electrode mixture layer 41. Here, the phrase “dividing the first positive electrode mixture layer 41 into two equal parts in the thickness direction of the first positive electrode mixture layer 41” means that, when the layering direction of the positive electrode current collector 40 and the first positive electrode mixture layer 41 is defined as the thickness direction of the first positive electrode mixture layer 41, the first positive electrode mixture layer 41 is divided into two equal parts at an intermediate Z1 of the thickness of the first positive electrode mixture layer 41. Of the two equal parts divided in the thickness direction of the first positive electrode mixture layer 41, a part of the first positive electrode mixture layer 41 located close to the positive electrode current collector 40 is defined as the lower half region 41a, and a part of the first positive electrode mixture layer 41 located far from the positive electrode current collector 40 is defined as the upper half region 41b.

In the present embodiment, when the second positive electrode mixture layer 42 is divided into two equal parts in the thickness direction, the dibutyl phthalate oil absorption of the positive electrode active material contained in an upper half region 42b is preferably larger than the dibutyl phthalate oil absorption of the positive electrode active material contained in a lower half region 42a. This makes it possible to further improve the permeation amount of the non-aqueous electrolyte into the second positive electrode mixture layer 42. Here, the phrase “dividing the second positive electrode mixture layer 42 into two equal parts in the thickness direction of the second positive electrode mixture layer 42” means that, when the layering direction of the positive electrode current collector and the second positive electrode mixture layer 42 is defined as the thickness direction of the second positive electrode mixture layer 42, the second positive electrode mixture layer 42 is divided into two equal parts at an intermediate Z2 of the thickness of the second positive electrode mixture layer 42. Of the two equal parts divided in the thickness direction of the second positive electrode mixture layer 42, a part of the second positive electrode mixture layer 42 located close to the positive electrode current collector 40 is defined as the lower half region 42a, and a part of the second positive electrode mixture layer 42 located far from the positive electrode current collector 40 is defined as the upper half region 42b.

Examples of the positive electrode active material include lithium-metal composite oxides containing transition metal elements such as Co, Mn, and Ni. Examples of the lithium-metal composite oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (M; at least one of Na, Mg, Sc, Y, Mn, Fe, Co, Ni, Cu, Zn, Al, Cr, Pb, Sb, and B, 0<x≤1.2, 0<y≤0.9, 2.0≤z≤2.3). These may be independently used, or two or more thereof may be used in combination. The positive electrode active material preferably contains a lithium-nickel composite oxide such as LiₓNiO₂, LiₓCo_{y}Ni_{1-y}O₂, or LiₓNi_{1-y}M_{y}Oₓ (M; at least one of Na, Mg, Sc, Y, Mn, Fe, Co, Ni, Cu, Zn, Al, Cr, Pb, Sb, and B, 0<x≤1.2, 0<y≤0.9, 2.0≤z≤2.3) from the viewpoint of achieving increase in the capacity of the non-aqueous electrolyte secondary battery.

The positive electrode active material is obtained, for example, by mixing a precursor and a lithium compound, and firing the mixture. The precursor is obtained, for example, by adding dropwise an alkali solution such as a sodium hydroxide solution to a solution containing metal salts of one or more metals such as transition metals while stirring the solution, adjusting the pH of the solution to the alkali side (for example, 8.5 to 11.5) to precipitate (coprecipitate) a metal hydroxide, and subjecting the precipitated metal hydroxide to heat treatment. Then, by adjusting the heat treatment temperature, the heat treatment time, and the like in the heat treatment, precursors having different dibutyl phthalate oil absorptions are obtained, and eventually, positive electrode active materials having different dibutyl phthalate oil absorptions are obtained.

Examples of the conductive agent include carbon particles such as carbon black (CB), acetylene black (AB), Ketjen black, carbon nanotube (CNT), and graphite. These may be independently used, or two or more thereof may be used in combination.

Examples of the binder include fluorine-based resin such as polytetrafluoroethylene (PTFE) or polyvinylidene fluoride (PVdF), polyacrylonitrile (PAN), polyimide-based resin, acrylic resin, and polyolefin-based resin. These may be independently used, or two or more thereof may be used in combination.

[Negative Electrode]

The negative electrode 12 includes a negative electrode current collector and a negative electrode mixture layer provided on the negative electrode current collector. For example, a foil of a metal which is stable within the potential range of the negative electrode, such as copper, a film in which the metal is disposed on a surface layer thereof, or the like is used for the negative electrode current collector.

The negative electrode mixture layer contains a negative electrode active material, and preferably further contains a binder, a conductive agent, and the like. The negative electrode 12 can be produced, for example, by preparing a negative electrode mixture slurry containing a negative electrode active material, a binder, and the like, applying the negative electrode mixture slurry onto a negative electrode current collector, drying the slurry to form a negative electrode mixture layer, and rolling the negative electrode mixture layer.

The negative electrode active material is capable of reversibly absorbing and releasing lithium ions, and examples thereof include carbon materials such as natural graphite and artificial graphite; metals alloyed with lithium, such as silicon (Si) and tin (Sn); alloys containing metal elements such as Si and Sn; and composite oxides.

Examples of the binder include fluorine-based resin, PAN, polyimide-based resin, acrylic resin, polyolefin-based resin, styrene-butadiene rubber (SBR), carboxymethyl cellulose (CMC) or a salt thereof, polyacrylic acid (PAA) or a salt thereof (PAA-Na, PAA-K, and the like, and a partially neutralized salt thereof may be used), and polyvinyl alcohol (PVA). These may be independently used, or two or more thereof may be used in combination.

Examples of the conductive agent include carbon particles such as carbon black (CB), acetylene black (AB), Ketjen black, carbon nanotube (CNT), and graphite. These may be independently used, or two or more thereof may be used in combination.

[Separator]

A porous sheet having ion permeability and insulation properties is used as the separator 13, for example. Specific examples of the porous sheet include a fine porous thin film, a woven fabric, and a nonwoven fabric. As material of the separator, olefin-based resin such as polyethylene or polypropylene, cellulose, or the like is suitable. The separator 13 may be a layered body having a cellulose fiber layer and a fiber layer of thermoplastic resin such as olefin-based resin. In addition, the separator 13 may be a multilayer separator having a polyethylene layer and a polypropylene layer, and a separator having a surface coated with a material such as aramid-based resin or ceramic may be used.

[Non-Aqueous Electrolyte]

The non-aqueous electrolyte contains a non-aqueous solvent and an electrolyte salt dissolved in the non-aqueous solvent. Examples of the non-aqueous solvent that can be used include esters, ethers, nitriles such as acetonitrile, amides such as dimethylformamide, and mixed solvents of two or more types thereof. The non-aqueous solvent may contain a halogen-substituted compound in which at least a part of hydrogen in these solvents is substituted with a halogen atom such as fluorine.

Examples of the esters include cyclic carbonic acid esters such as ethylene carbonate (EC), propylene carbonate (PC), and butylene carbonate; chain carbonic acid esters such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylic acid esters such as γ-butyrolactone and γ-valerolactone; and chain carboxylic acid esters such as methyl acetate, ethyl acetate, propyl acetate, methyl propionate (MP), and ethyl propionate.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, and crown ether; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted compound, it is preferable to use a fluorinated cyclic carbonic acid ester such as fluoroethylene carbonate (FEC), a fluorinated chain carbonic acid ester, a fluorinated chain carboxylic acid ester such as methyl fluoropropionate (FMP), or the like.

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ(1<x<6, n is 1 or 2), LiB₁₀Cl₁₀, LiCl, LiBr, LiI, chloroborane lithium, lower aliphatic lithium carboxylate, borates such as Li₂B₄O₇ and Li(B(C₂O₄)F₂), and imide salts such as LiN(SO₂CF₃)₂ and LiN(CₗF₂ₗ₊ₗSO₂)(CₘF₂ₘ₊₁SO₂) {l and m are each an integer of 1 or more}. These lithium salts may be independently used, or two or more thereof may be used in combination. Among them, LiPF₆ is preferably used from the viewpoint of ion conductivity, electrochemical stability, and the like. The concentration of the lithium salt is preferably 0.8 to 1.8 mol per 1 L of the solvent.

### EXAMPLES

Hereinafter, the present disclosure will be further described with reference to examples, but the present disclosure is not limited to these examples.

(Preparation of Lithium-Metal Composite Oxide A)

A precursor obtained by preparing a nickel-cobalt-aluminum composite hydroxide by coprecipitation and then subjecting the nickel-cobalt-aluminum composite hydroxide to heat treatment, and lithium hydroxide monohydrate (LiOH H₂O) were mixed such that the atomic ratio among lithium, nickel, cobalt, and aluminum was Li:Ni:Co:Al=1.00:0.82:0.15:0.03. The mixed powder was fired at 750° C. for 15 hours in an electric furnace under an oxygen atmosphere to obtain a lithium-metal composite oxide A.

(Preparation of Lithium-Metal Composite Oxides B to F)

The lithium-metal composite oxides B to F were prepared under the same conditions as for the lithium-metal composite oxide A except that the heat treatment temperature and the heating time in the heat treatment of the nickel-cobalt-aluminum composite hydroxide were changed.

Table 1 summarizes the dibutyl phthalate oil absorptions of the lithium-metal composite oxides A to F. The method for measuring the dibutyl phthalate oil absorption is as described above.

TABLE 1

| | Dibutyl phthalate oil absorption |
|---|---|
| | (mL/100 g) |
| Lithium-metal composite oxide A | 9.8 |
| Lithium-metal composite oxide B | 11.0 |
| Lithium-metal composite oxide C | 15.0 |
| Lithium-metal composite oxide D | 19.0 |
| Lithium-metal composite oxide E | 23.0 |
| Lithium-metal composite oxide F | 24.2 |

### Example 1

[Production of Positive Electrode]

In an N-methylpyrrolidone (NMP) solvent, the lithium-metal composite oxide B as a positive electrode active material, acetylene black as a conductive agent, and polyvinylidene fluoride (PVDF) having an average molecular weight of 1,100,000, as a binder, were mixed at a mass ratio of 98:1:1 to prepare a slurry having a solid content of 70 mass %. This was used as a first positive electrode mixture slurry.

In addition, in an N-methylpyrrolidone (NMP) solvent, the lithium-metal composite oxide E as a positive electrode active material, acetylene black as a conductive agent, and polyvinylidene fluoride (PVDF) having an average molecular weight of 1,100.000, as a binder, were mixed at a mass ratio of 98:1:1 to prepare a slurry having a solid content of 70 mass %. This was used as a second positive electrode mixture slurry.

The first positive electrode mixture slurry was applied to one face of an aluminum foil having a thickness of 15 μm, and the second positive electrode mixture slurry was applied to the other face of the aluminum foil. Thereafter, the slurry was dried, and the coated film was rolled with a rolling roller to produce a positive electrode including a first positive electrode mixture layer formed on one face of a positive electrode current collector and a second positive electrode mixture layer formed on the other face of the positive electrode current collector.

[Production of Negative Electrode]

First, 95 parts by mass of graphite powder, 5 parts by mass of Si oxide, and 1 part by mass of carboxymethyl cellulose (CMC) were mixed together with an appropriate amount of water. To this mixture, 1.2 parts by mass of styrene-butadiene rubber (SBR) and an appropriate amount of water were added to prepare a negative electrode mixture slurry. The negative electrode mixture slurry was applied to both faces of a copper foil having a thickness of 8 μm, and then the coated film was dried and rolled with a rolling roller to prepare a negative electrode including a negative electrode mixture layer formed on both faces of a negative electrode current collector.

[Preparation of Non-Aqueous Electrolyte]

To 100 parts by mass of a mixed solvent composed of ethylene carbonate (EC) and methylethyl carbonate (MEC) (EC:DMC=1:3 at a volume ratio), 5 parts by mass of vinylene carbonate (VC) was added, and LiPF₆ was dissolved therein at a concentration of 1 mol/L. This was used as a non-aqueous electrolyte.

[Production of Secondary Battery]

(1) A lead was attached to each of the positive electrode and the negative electrode, then a polyethylene separator having a thickness of 20 μm is disposed between the positive electrode and the negative electrode, and these members are wound such that the first positive electrode mixture layer of the positive electrode is on the outer circumference side, and the second positive electrode mixture layer of the positive electrode is on the inner circumference side, to produce a wound electrode assembly.

(2) The electrode assembly was inserted into a case body, the lead on the negative electrode side was welded to the bottom of the case body, and the lead on the positive electrode side was welded to a sealing assembly.

(3) The non-aqueous electrolyte was injected into the case body, and then the opening end of the case body was crimped to the sealing assembly with a gasket interposed therebetween. This was subjected to non-aqueous electrolysis to obtain a secondary battery.

### Example 2

A non-aqueous electrolyte secondary battery was produced in the same manner as in Example 1 except that the lithium-metal composite oxide D was used as a positive electrode active material used for the first positive electrode mixture slurry.

### Example 3

A non-aqueous electrolyte secondary battery was produced in the same manner as in Example 1 except that the lithium-metal composite oxide C was used as a positive electrode active material used for the second positive electrode mixture slurry.

### Example 4

A non-aqueous electrolyte secondary battery was produced in the same manner as in Example 1 except that the lithium-metal composite oxide A was used as a positive electrode active material used for the first positive electrode mixture slurry.

### Example 5

A non-aqueous electrolyte secondary battery was produced in the same manner as in Example 1 except that the lithium-metal composite oxide B was used as a positive electrode active material used for the first positive electrode mixture slurry and the lithium-metal composite oxide F was used as a positive electrode active material used for the second positive electrode mixture slurry.

### Comparative Example 1

A non-aqueous electrolyte secondary battery was produced in the same manner as in Example 1 except that the lithium-metal composite oxide E was used as a positive electrode active material used for the first positive electrode mixture slurry and the lithium-metal composite oxide B was used as a positive electrode active material used for the second positive electrode mixture slurry.

### Comparative Example 2

A non-aqueous electrolyte secondary battery was produced in the same manner as in Example 1 except that the lithium-metal composite oxide B, which was the same as the first positive electrode mixture slurry, was used as a positive electrode active material used for the second positive electrode mixture slurry.

### Comparative Example 3

A non-aqueous electrolyte secondary battery was produced in the same manner as in Example 1 except that the lithium-metal composite oxide E, which was the same as the second positive electrode mixture slurry, was used as a positive electrode active material used for the first positive electrode mixture slurry.

[Evaluation of Charge-Discharge Cycle Characteristics]

Each of the non-aqueous electrolyte secondary batteries of Examples and Comparative Examples was charged at a constant current of 0.7 It under a temperature environment of 25° C. until the voltage reached 4.2 V, and then charged at a constant voltage of 4.2 V until the current reached 0.05 It. The battery was then discharged at a constant current of 0.7 It until the voltage reached 2.5 V This charge-discharge cycle was defined as 1 cycle, 300 cycles were performed, and the capacity retention rate was determined by the following formula.

Capacity retention rate (%)=(discharge capacity at 300th cycle/discharge capacity at 1st cycle)×100

Table 2 summarizes the results of the charge-discharge cycle characteristics of Examples and Comparative Examples.

TABLE 2

| | Dibutyl phthalate oil absorption of positive | | |
|---|---|---|---|
| | electrode active material (mL/100 g) | | |
| | First positive | Second positive | Capacity |
| | electrode | electrode | retention |
| | mixture layer | mixture layer | rate |
| Example 1 | 11.0 | 23.0 | 88% |
| Example 2 | 19.0 | 23.0 | 85% |
| Example 3 | 11.0 | 15.0 | 86% |
| Example 4 | 9.8 | 23.0 | 80% |
| Example 5 | 11.0 | 24.2 | 79% |
| Comparative | 23.0 | 11.0 | 71% |
| Example 1 | | | |
| Comparative | 11.0 | 11.0 | 75% |
| Example 2 | | | |
| Comparative | 23.0 | 23.0 | 76% |
| Example 3 | | | |

In all of Examples 1 to 5, the capacity retention rates were higher than those in Comparative Examples 1 to 3. From these, as in Examples 1 to 5, deterioration of charge-discharge cycle characteristics can be suppressed by using a positive electrode in which the dibutyl phthalate oil absorption of the positive electrode active material contained in the first positive electrode mixture layer that is formed on the first face of the positive electrode current collector and faces the outside of the electrode assembly is smaller than the oil absorption of the positive electrode active material contained in the second positive electrode mixture layer that is formed on the second face of the positive electrode current collector and faces the inside of the electrode assembly. In Examples 1 to 5, since Examples 1 to 3 showed a capacity retention rate of greater than or equal to 85%, the dibutyl phthalate oil absorption of the positive electrode active material contained in the first positive electrode mixture layer is preferably greater than or equal to 11 mL/100 and less than or equal to 19 mL/100 g, and the dibutyl phthalate oil absorption of the positive electrode active material contained in the second positive electrode mixture layer is preferably greater than or equal to 15 mL/100 g and less than or equal to 23 mL/100 from the viewpoint of further suppressing charge-discharge cycle characteristics.

### REFERENCE SIGNS LIST

10 Non-aqueous electrolyte secondary battery
11 Positive electrode
12 Negative electrode
13 Separator
14 Electrode assembly
15 Battery case
16 Case body
17 Sealing assembly
18, 19 Insulating plate
20 Positive electrode lead
21 Negative electrode lead
22 Projecting portion
23 Filter
24 Lower vent member
25 Insulating member
26 Upper vent member
27 Cap
28 Gasket
40 Positive electrode current collector
41 First positive electrode mixture layer
41a, 42a Lower half region
41b, 42b Upper half region
42 Second positive electrode mixture layer

1. A non-aqueous electrolyte secondary battery comprising:
an electrode assembly including a positive electrode, a negative electrode, and a separator, the positive electrode and the negative electrode being wound with the separator interposed between the positive electrode and the negative electrode, the electrode assembly being a wound electrode assembly, wherein
the positive electrode has: a positive electrode current collector; a first positive electrode mixture layer that is formed on a first face of the positive electrode current collector and faces an outside of the electrode assembly; and a second positive electrode mixture layer that is formed on a second face of the positive electrode current collector and faces an inside of the electrode assembly,
the first positive electrode mixture layer and the second positive electrode mixture layer contain a positive electrode active material, and
a dibutyl phthalate oil absorption of the positive electrode active material contained in the first positive electrode mixture layer is smaller than a dibutyl phthalate oil absorption of the positive electrode active material contained in the second positive electrode mixture layer.

2. The non-aqueous electrolyte secondary battery according to claim 1, wherein the dibutyl phthalate oil absorption of the positive electrode active material contained in the first positive electrode mixture layer is greater than or equal to 11 mL/100 g and less than or equal to 19 mL/100 g, and the dibutyl phthalate oil absorption of the positive electrode active material contained in the second positive electrode mixture layer is greater than or equal to 15 mL/100 g and less than or equal to 23 mL/100 g.
